(19) United States
(12) Patent Application Publication
(10) Pub. No.: US 2017/0359159 A1
(43) Pub. Date: Dec. 14, 2017

(54) METHOD FOR TRANSMITTING AND RECEIVING ACKNOWLEDGMENT SIGNAL FOR UPLINK MULTI-USER DATA IN WLAN SYSTEM AND DEVICE THEREFOR

(71) Applicant: LG ELECTRONICS INC., Seoul (KR)

(72) Inventors: Jeongki KIM, Seoul (KR); Kiseon RYU, Seoul (KR); Hangyu CHO, Seoul (KR); Suhwook KIM, Seoul (KR)

(73) Assignee: LG ELECTRONICS INC., Seoul (KR)

(21) Appl. No.: 15/524,240

(22) PCT Filed: Nov. 30, 2015
(86) PCT No.: PCT/KR2015/012905

§ 371 Date: May 3, 2017

Related U.S. Application Data
(60) Provisional application No. 62/085,628, filed on Nov. 30, 2014.
(60) Provisional application No. 62/114,002, filed on Feb. 9, 2015.
(60) Provisional application No. 62/189,759, filed on Jul. 8, 2015.

(51) Int. Cl. H04L 5/00; H04W 72/04; H04W 84/12

(52) U.S. Cl. CPC H04L 5/0055; H04W 72/0446; H04L 5/005; H04W 84/12; H04L 5/0007

(57) ABSTRACT

The present document relates to a method for transmitting, by an access point, an ACK/NACK signal for transmission data from a plurality of stations (STA) in a WLAN system and a device for the same. To this end, the AP transmits a trigger frame to the plurality of stations STA, receives the data transmitted from the plurality of STA in response to the trigger frame, and transmits the ACK/NACK signal for the data received from the plurality of STA. In this process, the ACK/NACK signal may be transmitted in the form of a multi-user block ACK (M-BA) frame that is composed of a 242 tones unit.

### TECHNICAL FIELD

The present disclosure relates to a method and apparatus for transmitting and receiving an Acknowledgment/Negative Acknowledgment (ACK/NACK) signal for multi-user or multi-Station (STA) data in a Wireless Local Area Network (WLAN) system.

### BACKGROUND ART

Standards for a WLAN technology have been developed as Institute of Electrical and Electronics Engineers (IEEE) 802.11 standards. IEEE 802.11a and b use an unlicensed band at 2.4 GHz or 5 GHz. IEEE 802.11b provides a transmission rate of 11 Mbps, and IEEE 802.11a provides a transmission rate of 54 Mbps. IEEE 802.11g provides a transmission rate of 54 Mbps by applying Orthogonal Frequency Division Multiplexing (OFDM) at 2.4 GHz. IEEE 802.11n provides a transmission rate of 300 Mbps for four spatial streams by applying Multiple Input Multiple Output (MIMO)-OFDM. IEEE 802.11n supports a channel bandwidth of up to 40 MHz and, in this case, provides a transmission rate of 600 Mbps.

The above-described WLAN standards have evolved into IEEE 802.11ac that uses a bandwidth of up to 160 MHz and supports a transmission rate of up to 1 Gbits/s for 8 spatial streams, and IEEE 802.11ax standards are under discussion.

### DISCLOSURE

### Technical Problem

In the IEEE 802.11ax standards, an Uplink (UL) Orthogonal Frequency Division Multiple Access (OFDMA) transmission scheme and a UL Multi-User (MU) transmission scheme will be used. Then, an Access Point (AP) may receive UL MU frames from a plurality of Stations (STAs) in the same transmission opportunity and needs to transmit an Acknowledgement (ACK) frame in response to the UL MU frames.

In this case, efficient transmission of an ACK/Negative ACK (NACK) signal to a plurality of STAs through a Block ACK (BA) frame may be considered. However, overhead may be problematic due to an increased size of an MU BA frame for a plurality of STAs.

Hereinafter, a method and apparatus for efficiently transmitting an ACK/NACK signal by minimizing overhead in a UL MU transmission situation will be described.

### Technical Solution

In an aspect of the present disclosure, a method for transmitting, by an access point (AP), an acknowledgment/negative acknowledgment (ACK/NACK) signal for transmission data of a plurality of stations (STAs) in a wireless local area network (WLAN) system includes transmitting a trigger frame to the plurality of STAs, receiving data from the plurality of STAs in response to the trigger frame, and transmitting an ACK/NACK signal for the data received from the plurality of STAs. The ACK/NACK signal is transmitted in a multi-user block ACK (M-BA) frame configured to include a 242-tone unit.

A specific M-BA frame transmitted in specific 242 tones may include an ACK/NACK signal for data received in the specific 242 tones.

Specifically, if a first group of data are received in first 242 tones from a first group of STAs among the plurality of STAs, and a second group of data are received in second 242 tones from a second group of STAs among the plurality of STAs, a first M-BA frame including ACK/NACK signals for the first group of STAs may be transmitted in the first 242 tones, and a second M-BA frame including ACK/NACK signals for the second group of STAs may be transmitted in the second 242 tones.

Meanwhile, if the first M-BA frame and the second M-BA frame have different time lengths, the time lengths of the first M-BA frame and the second M-BA frame may be made equal by inserting a padding in an M-BA frame having a shorter time length.

The M-BA frame may be configured in a PLCP protocol data unit (PPDU) format having a legacy-part (L-Part), a high efficiency signal A (HE-SIG A), a high efficiency signal B (HE-SIG B), a high efficiency short training field (HE-STF), a high efficiency long training field (HE-LTF), and a data field including a plurality of ACK/NACK signals.

In this case, the HE-SIG B may include information for decoding the plurality of ACK/NACK signals in the data field.

Meanwhile, the M-BA frame may be configured in a PPDU format including an MU block ACK MAC protocol data unit (MPDU) after an L-Part.

The AP may indicate, to the plurality of STAs,

ACK/NACK type information indicating whether ACK/NACK signals are transmitted

(1) in M-BA frames duplicated on a 242-tone basis,

(2) in M-BA frames each including an independent ACK/NACK signal on a 242-tone basis, or

(3) in OFDMA.

The AP may transmit the ACK/NACK type information in the trigger frame, which should not be construed as limiting.

In another aspect of the present disclosure, a method for receiving, from an AP, an ACK/NACK signal for transmission data by a STA in a WLAN system includes receiving a trigger frame directed to a plurality of STAs including the first STA, transmitting a plurality of data to the AP in an uplink multi-user scheme or orthogonal frequency division multiple access (OFDMA) in response to the trigger frame, and receiving an ACK/NACK signal for the data from the AP. The ACK/NACK signal is received in a multi-user block ACK (M-BA) frame configured to include a 242-tone unit.

In another aspect of the present disclosure, an AP for transmitting an ACK/NACK signal for transmission data of a plurality of STAs in a WLAN system includes a transceiver configured to transmit a trigger frame to the plurality of STAs, receive data from the plurality of STAs in response to the trigger frame, and transmit an ACK/NACK signal for the data received from the plurality of STAs, and a processor connected to the transceiver and configured to process the trigger frame, the received data, and the ACK/NACK signal. The processor configures the ACK/NACK signal in an M-BA frame configured to include a 242-tone unit.

In another aspect of the present disclosure, an STA operating as a first STA for receiving, from an AP, an ACK/NACK signal for transmission data in a WLAN system includes a transceiver configured to receive a trigger frame directed to a plurality of STAs including the first STA, transmit a plurality of data to the AP in an uplink multi-user scheme or OFDMA in response to the trigger frame, and receive an ACK/NACK signal for the data from the AP, and a processor connected to the transceiver and configured to process the trigger frame, the received data, and the ACK/NACK signal. The processor is configured to process an ACK/NACK signal received in an M-BA frame configured to include a 242-tone unit.

### Advantageous Effects

According to the present disclosure as described above, an Access Point (AP) may efficiently transmit an Acknowledgment/Negative Acknowledgment (ACK/NACK) signal to a plurality of Stations (STAs) by minimizing overhead in an Uplink (UL) Multi-User (MU) transmission situation.

### BRIEF DESCRIPTION OF THE DRAWINGS

FIG. 1 is a diagram illustrating an exemplary configuration of a Wireless Local Area Network (WLAN) system.

FIG. 2 is a diagram illustrating another exemplary configuration of a WLAN system.

FIG. 3 is a diagram illustrating a Block Acknowledgment (ACK) mechanism used in a WLAN system.

FIG. 4 is a diagram illustrating a basic configuration of a Block ACK (BA) frame.

FIG. 5 is a diagram illustrating a detailed configuration of a BA Control field illustrated in FIG. 4.

FIG. 6 is a diagram illustrating a detailed configuration of a BA Information field illustrated in FIG. 4.

FIG. 7 is a diagram illustrating a configuration of a Block Ack Starting Sequence Control subfield.

FIG. 8 is a diagram illustrating a configuration of a BA Information field of a compressed Block ACK frame.

FIG. 9 is a diagram illustrating a BA Information field of a Multi-Traffic Identifier (TID) Block ACK frame.

FIGS. 10 and 11 are diagrams illustrating a case in which a Block ACK mechanism is applied to a Downlink (DL) Multi-User Multiple Input Multiple Output (MU-MIMO) scheme.

FIG. 12 is a diagram illustrating an Uplink (UL) MU transmission situation to which the present disclosure is applicable.

FIG. 13 is a diagram illustrating a frame structure to be used for a DL MU Block ACK mechanism according to a preferred embodiment of the present disclosure.

FIGS. 14 and 15 are diagrams illustrating a problem encountered with use of a general MU Block ACK (M-BA) frame.

FIG. 16 is a diagram illustrating an M-BA transmission mechanism according to a preferred embodiment of the present disclosure.

FIG. 17 is a diagram illustrating an advantage of using Orthogonal Frequency Division Multiple Access (OFDMA) M-BA frames illustrated in FIG. 16.

FIG. 18 is a diagram illustrating a specific mechanism using the OFDMA M-BA frames illustrated in FIG. 16.

FIGS. 19 and 20 are diagrams illustrating specific formats of an M-BA frame according to an embodiment of the present disclosure.

FIG. 21 is a diagram illustrating exemplary transmission of DL MU BAs by an AP, when UL MU frames are transmitted in 80 MHz.

FIG. 22 is a diagram illustrating the problem of different time lengths of M-BA frames, when the M-BA frames are transmitted in chunk units.

FIG. 23 is a diagram illustrating a method for matching the time lengths of M-BAs in a plurality of bands to each other by padding according to an embodiment of the present disclosure.

FIG. 24 is a diagram illustrating an operation of a Station (STA) which has failed to receive an M-BA frame according to an embodiment of the present disclosure.

FIGS. 25 and 26 are diagrams illustrating an operation performed when an ACK/BA type is set according to an embodiment of the present disclosure.

FIG. 27 is a block diagram of apparatuses for implementing the above methods.

### BEST MODE FOR CARRYING OUT THE INVENTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention.

The following detailed description includes specific details in order to provide a thorough understanding of the present invention. However, it will be apparent to those skilled in the art that the present invention may be practiced without such specific details. In some instances, known structures and devices are omitted or are shown in block diagram form, focusing on important features of the structures and devices, so as not to obscure the concept of the present invention.

As described above, the following description relates to a method for efficiently utilizing a channel having a wide bandwidth in a Wireless Local Area Network (WLAN) system and an apparatus therefor. To this end, a WLAN system to which the present invention is applicable will be described first in detail.

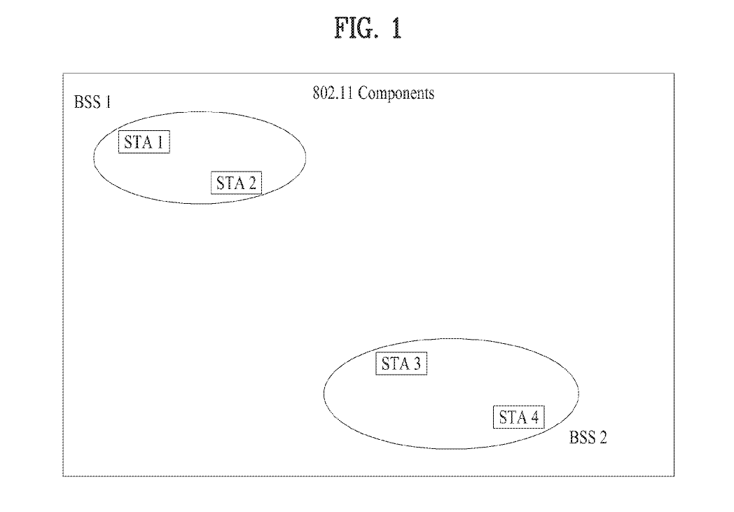

FIG. 1 is a diagram illustrating an exemplary configuration of a WLAN system.

As illustrated in FIG. 1, the WLAN system includes at least one Basic Service Set (BSS). The BSS is a set of Stations (STAs) that are able to communicate with each other by successfully performing synchronization.

An STA is a logical entity including a physical layer interface between a Media Access Control (MAC) layer and a wireless medium. The STA may include an Access Point (AP) and a non-AP STA. Among STAs, a portable terminal manipulated by a user is the non-AP STA. If a terminal is simply called an STA, the STA refers to the non-AP STA. The non-AP STA may also be referred to as a terminal, a Wireless Transmit/Receive Unit (WTRU), a User Equipment (UE), a Mobile Station (MS), a mobile terminal, or a mobile subscriber unit.

The AP is an entity that provides access to a Distribution System (DS) to an associated STA through a wireless medium. The AP may also be referred to as a centralized controller, a Base Station (BS), a Node-B, a Base Transceiver System (BTS), or a site controller.

The BSS may be divided into an infrastructure BSS and an Independent BSS (IBSS).

The BSS illustrated in FIG. 1 is the IBSS. The IBSS refers to a BSS that does not include an AP. Since the IBSS does not include the AP, the IBSS is not allowed to access to the DS and thus forms a self-contained network.

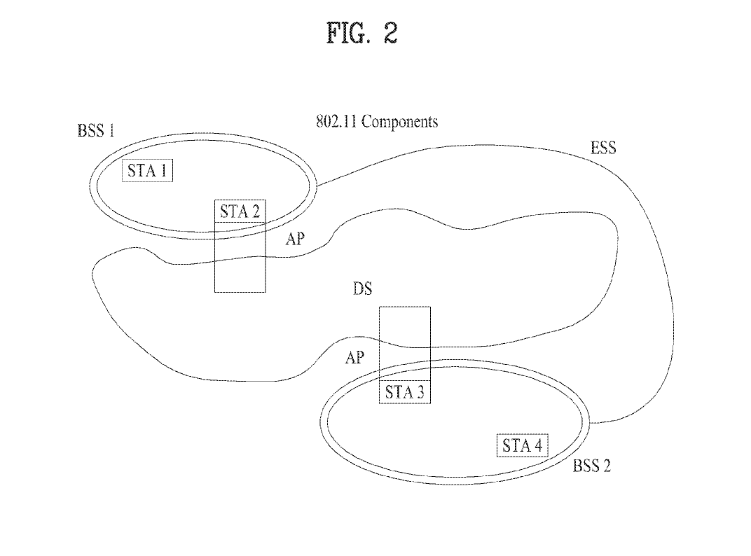

FIG. 2 is a diagram illustrating another exemplary configuration of a WLAN system.

BSSs illustrated in FIG. 2 are infrastructure BSSs. Each infrastructure BSS includes one or more STAs and one or more APs. In the infrastructure BSS, communication between non-AP STAs is basically conducted via an AP. However, if a direct link is established between the non-AP STAs, direct communication between the non-AP STAs may be performed.

As illustrated in FIG. 2, the multiple infrastructure BSSs may be interconnected via a DS. The BSSs interconnected via the DS are called an Extended Service Set (ESS). STAs included in the ESS may communicate with each other and a non-AP STA within the same ESS may move from one BSS to another BSS while seamlessly performing communication.

The DS is a mechanism that connects a plurality of APs to one another. The DS is not necessarily a network. As long as it provides a distribution service, the DS is not limited to any specific form. For example, the DS may be a wireless network such as a mesh network or may be a physical structure that connects APs to one another.

Based on the above description, a Block Acknowledgment (ACK) scheme in a WLAN system will be described hereinbelow.

The Block ACK mechanism is a scheme of improving channel efficiency by aggregating and then transmitting a plurality of ACKs in one frame. There are two types of Block ACK mechanism schemes: an immediate ACK scheme and a delayed ACK scheme. The immediate ACK scheme may be suitable for high-bandwidth, low-latency traffic transmission, whereas the delayed ACK scheme is favorable for applications that can tolerate latency. Unless particularly specified otherwise in the below description, an STA that transmits data using the Block ACK mechanism is referred to as an originator and an STA that receives the data using the Block ACK mechanism is referred to as a recipient.

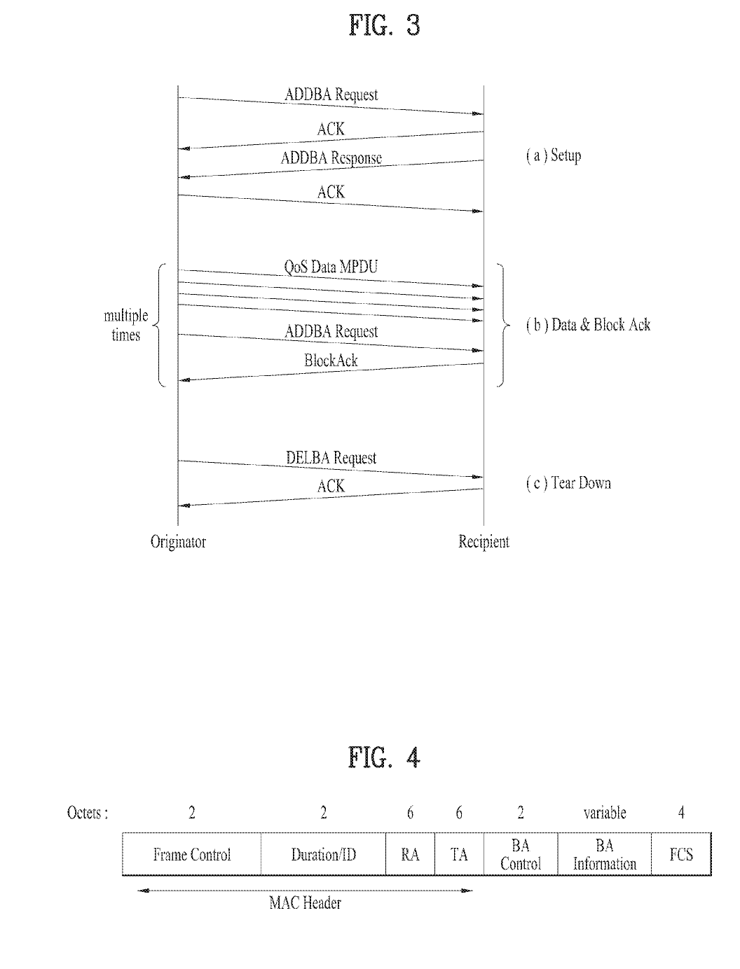

FIG. 3 is a diagram illustrating a Block ACK mechanism used in a WLAN system.

The Block ACK mechanism may be initialized by an exchange of Add Block Acknowledgment (ADDBA) request/response frames as illustrated in FIG. 3 ((a) Setup step). After the Block ACK mechanism is initialized, a block of Quality of Service (QoS) data frames may be transmitted by an originator to a recipient. Such a block may be started within a polled Transmission Opportunity (TXOP) or by winning Enhanced Distributed Channel Access (EDCA) contention. The number of frames in the block may be limited. MAC Packet Data Units (MPDUs) in the block of frames may be acknowledged by a BlockAck frame, which is requested by a BlockAckReq frame ((b) Data & Block ACK step).

When the originator has no data to transmit and a final Block ACK exchange is completed, the originator may end the Block ACK mechanism by transmitting a Delete Block Acknowledgment (DELBA) frame to the recipient. Upon receiving the DELBA frame, the recipient may release all resources allocated for Block ACK transfer ((c) Tear Down step).

FIG. 4 is a diagram illustrating a basic configuration of a Block ACK frame.

The Block ACK frame may include a MAC Header field, a Block ACK (BA) Control field, and a BA Information field. The MAC Header field may include a Frame Control field, a Duration/ID field, an RA field, and a TA field. Herein, the RA field represents an address of a receiver STA and the TA field represents an address of a transmitter STA.

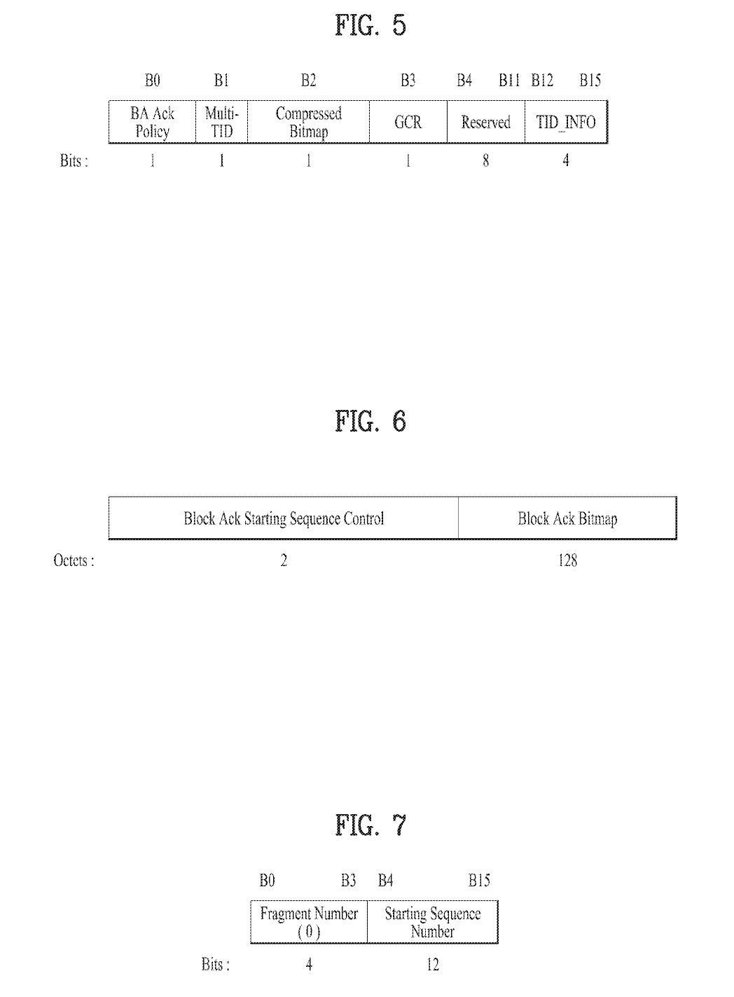

FIG. 5 is a diagram illustrating a detailed configuration of the BA Control field illustrated in FIG. 4.

A value of a BA ACK Policy subfield in the BA Control field may have the meaning shown in Table 1 below.

TABLE 1

| Value | Meaning |
|---|---|
| 0 | Normal Acknowledgment. |
| | The BA Ack Policy subfield is set to this value when |
| | the sender requires immediate acknowledgment. |
| | The addressee returns an Ack frame. |
| | The value 0 is not used for data sent under HT-delayed |
| | Block Ack during a PSMP sequence. |
| | The value 0 is not used in frames transmitted by DMG STAs. |
| 1 | No Acknowledgment. |
| | The addressee sends no immediate response upon |
| | receipt of the frame. |
| | The BA Ack Policy is set to this value when the sender does |
| | not require immediate acknowledgment. |
| | The value 1 is not used in a Basic BlockAck frame outside a |
| | PSMP sequence. |
| | The value 1 is not used in an Multi-TID BlockAck frame. |

Meanwhile, Multi-Traffic Identifier (Multi-TID), Compressed Bitmap, and GCR subfields in the BA Control field may determine possible BlockAck frame variants according to the following regulation.

TABLE 2

| | | GCR | |
|---|---|---|---|
| Multi-TID | Compressed Bitmap | subfield | |
| subfield value | subfield value | value | BlockAck frame variant |
| 0 | 0 | 0 | Basic BlockAck |
| 0 | 1 | 0 | Compressed BlockAck |
| 1 | 0 | 0 | Extended Compressed |
| | | | BlockAck |
| 1 | 1 | 0 | Multi-TID BlockAck |
| 0 | 0 | 1 | Reserved |
| 0 | 1 | 1 | GCR BlockAck |
| 1 | 0 | 1 | Reserved |
| 1 | 1 | 1 | Reserved |

FIG. 6 is a diagram illustrating a detailed configuration of the BA Information field illustrated in FIG. 4, and FIG. 7 is a diagram illustrating a configuration of a Block Ack Starting Sequence Control subfield.

As illustrated in FIG. 6, the BA Information field may include a Block Ack Starting Sequence Control (SSC) subfield and a Block Ack Bitmap subfield.

As illustrated in FIG. 6, the Block Ack Bitmap subfield is 128 octets in length and thus may represent a reception status of 64 MAC Service Data Units (MSDUs). If a bit position n of the Block Ack Bitmap subfield is set to 1, this may indicate that an MPDU having an MPDU sequence control value corresponding to (SSC+n) has been successfully received, wherein SSC denotes a value of the Block Ack Starting Sequence Control subfield. In contrast, if the bit position n of the Block ACK Bitmap field is set to 0, this may indicate that the MPDU having the MPDU sequence control value corresponding to (SSC+n) has not been received. Each of values of an MPDU Sequence Control field and the Block Ack Starting Sequence Control subfield may be treated as a 16-bit unsigned integer. For unused fragment numbers of an MSDU, corresponding bits in a bitmap may be set to 0.

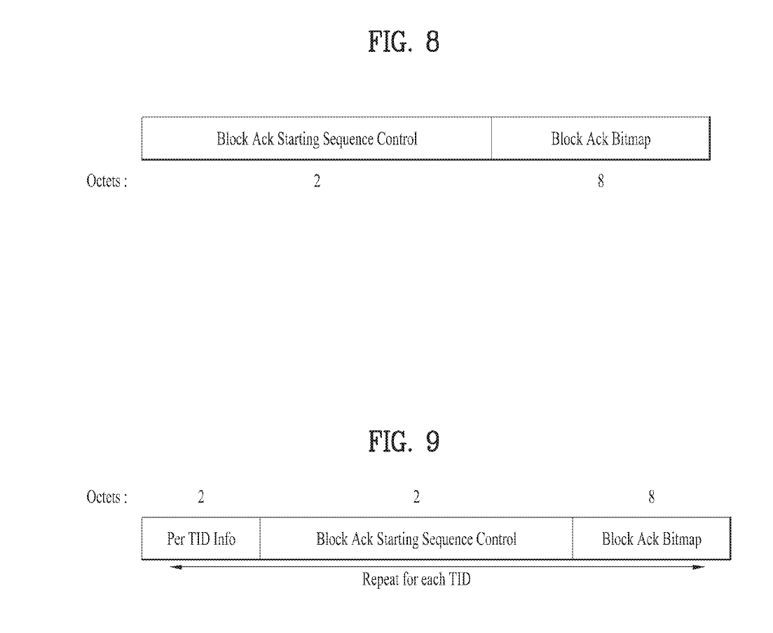

FIG. 8 is a diagram illustrating a configuration of a BA Information field of a compressed Block ACK frame

As illustrated in FIG. 8, a Block Ack Bitmap subfield of the BA Information field of the compressed Block ACK frame may be 8 octets in length and indicate a reception status of 64 MAC Service data Units (MSDUs) and Aggregate MSDUs (A-MSDUs). The first bit of a bitmap corresponds to an MSDU or an A-MSDU matching a value of a Block Ack Starting Sequence Control subfield and respective bits may sequentially correspond to MSDUs or A-MSDUs after the above MSDU or the A-MSDU.

FIG. 9 is a diagram illustrating a BA Information field of a Multi-TID Block ACK frame.

A TID_INFO subfield of the BA Information field of the Multi-TID Block ACK frame contains information about the number of TIDs in the BA Information field. Specifically, a value of the TID_INFO subfield represents (the number of TIDs corresponding to information of the BA Information field)−1. For example, if the value of the TID_INFO subfield is 2, this may indicate that the BA Information field contains information about three TIDs.

Meanwhile, the Multi-TID Block ACK frame may include a Per TID Info subfield in addition to a Block Ack Starting Sequence Control subfield and a Block Ack Bitmap subfield as illustrated in FIG. 9. The first emerging Per TID Info, Block Ack Starting Sequence Control, and Block Ack Bitmap subfields may be transmitted in correspondence to the lowest TID value and subsequently repeated subfields may correspond to the next TID. A triplet of these subfields may be repeated per TID.

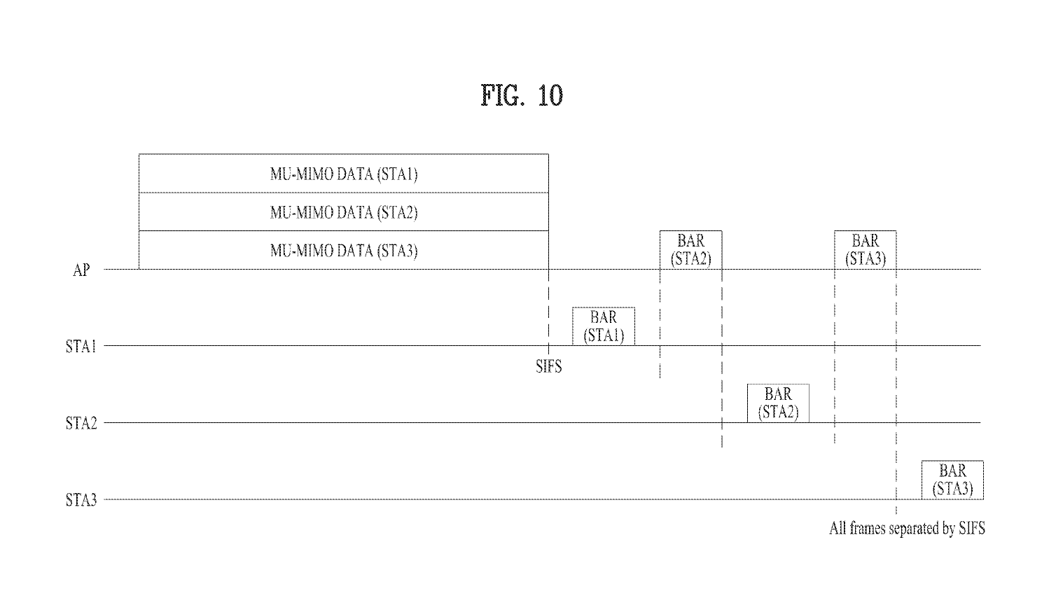

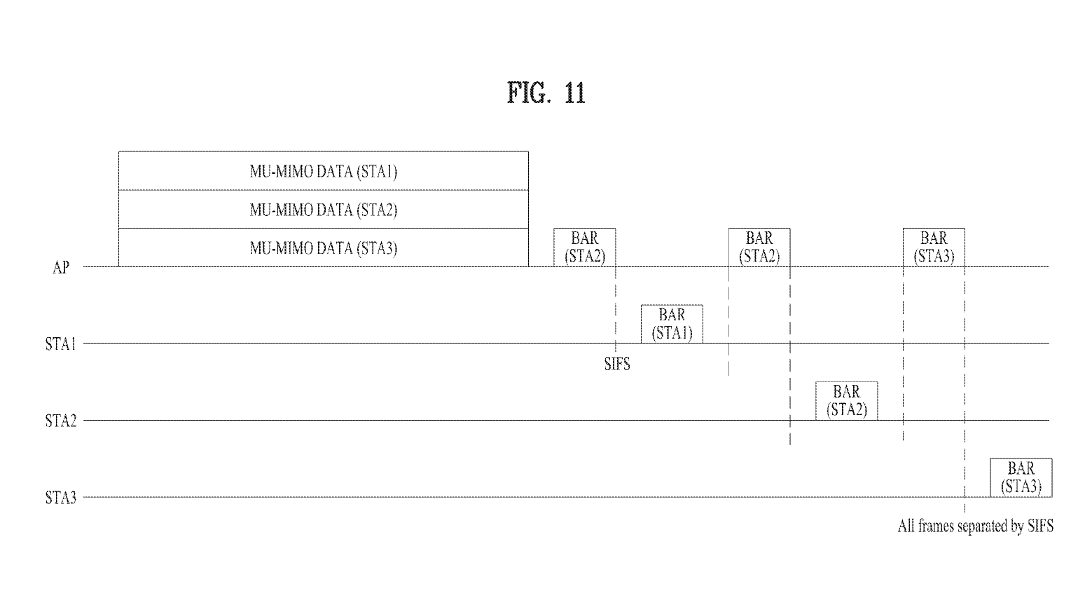

FIGS. 10 and 11 are diagrams illustrating a case in which a Block ACK mechanism is applied to a Downlink (DL) Multi-User Multiple Input Multiple Output (MU-MIMO) scheme.

As illustrated in FIGS. 10 and 11, an AP may transmit MU-MIMO data frames to a plurality of STAs, STA 1 to STA 3.

It is assumed in FIG. 10 that frame exchange is performed after a Short InterFrame Space (SIFS) after an MU PLCP Packet Data Unit (PPDU) is transmitted. It is also assumed in FIG. 10 that for STA1, an implicit Block Ack request is configured as Ack policy and, for STA 2 and STA 3, a Block ACK is configured as Ack policy. Then, STA 1 may immediately transmit a BA frame after receiving a DL MU PPDU even without receiving a request for the Block ACK. In contrast, the AP may perform polling by transmitting a BA Request (BAR) frame to STA 2 and STA 3 and then STA 2 and STA 3 may transmit BA frames.

Meanwhile, FIG. 11 illustrates an example of performing a frame exchange without an SIFS after an MU PPDU is transmitted and it is assumed that a Block ACK is configured as ACK policy for all STAs. Therefore, the AP may perform polling by transmitting a BAR frame to all STAs.

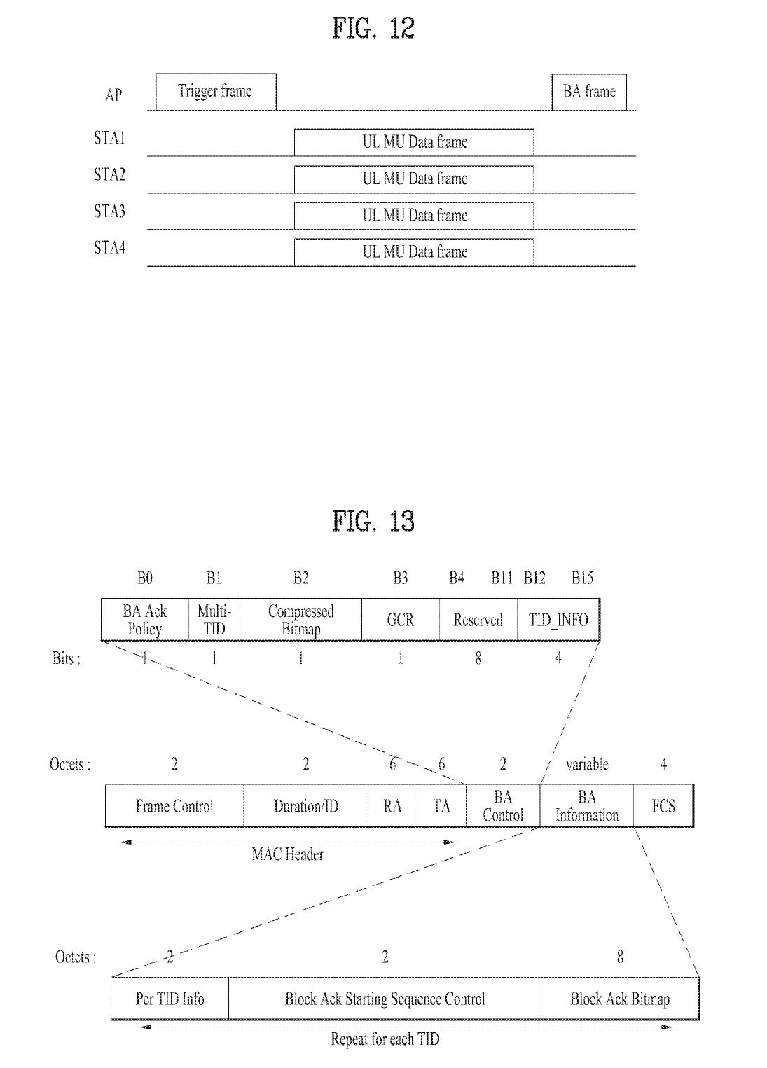

FIG. 12 is a diagram for explaining a UL MU transmission situation to which the present disclosure is applicable.

A UL MU transmission scheme may be used in an 802.11ax system as described above and may be initialized when an AP transmits a trigger frame to a plurality of STAs (e.g., STA 1 to STA 4) as illustrated in FIG. 12. The trigger frame may include UL MU allocation information (e.g. resource location and size, STA IDs, an MCS, and an MU type (MIMO, OFDMA, etc.)). Specific examples of information transmitted in the trigger frame may be as follows.

```
TABLE 3
Duration of UL MU frame
Number of allocation (N)
Each allocation's Information
    SU/MU
    AID (in MU, as many AIDs as the number of STAs are additionally
    included.)
    Power adjustment
    Tone(/Resource) allocation information (e.g., bitmap)
    MCS
    Nsts
    STBC
    Coding
    Beamformed
    Etc.
```

Meanwhile, as illustrated in FIG. 12, the AP may obtain a TXOP for transmitting the trigger frame via a contention procedure in order to access a medium. The STAs may transmit UL data frames with a format indicated by the AP after an SIFS of the trigger frame. It is assumed that the AP according to the present invention transmits an ACK of the UL MU data frames through a BA frame.

However, the above-described BA frame for the UL MU frames considerably increases in size as compared with a BA frame for a UL MU frame, thereby causing a serious overhead problem. For example, the BA frame transmitted by STA 1 in FIGS. 10 and 11 includes BA information about data transmitted by the AP to STA 1, whereas the BA frame transmitted by the AP in FIG. 12 includes BA information about the UL MU data frames transmitted by STA 1 to STA 4. In addition, since the size of a MAC frame corresponds to 32 bytes when a compressed Block ACK is used and 150 bytes when a normal Block ACK is used, overhead may be problematic.

Accordingly, an embodiment of the present disclosure proposes a method for efficiently transmitting a BA frame in a UL MU situation, using a multi-TID BA frame format among the foregoing BA frames.

FIG. 13 is a diagram illustrating a frame structure to be used for a DL MU Block ACK mechanism according to an embodiment of the present disclosure.

A multi-STA BA frame to be used according to an embodiment of the present disclosure may basically be configured in the multi-TID BA frame format illustrated in FIG. 13, and may preferably include an indicator indicating that the BA frame is not a simple multi-TID BA frame but a multi-STA BA frame. Accordingly, a BA Information field may include BA information about different STAs, as compared to the conventional BA Information field.

In FIG. 13, a Multi-AID field of the BA Control field indicates whether Block ACK information including AID information is included in the BA Information field, and Block ACK information (Block Ack Starting Sequence Control and Block Ack Bitmap) may be included per AID.

In this case, if the number of STAs increases, the overhead of the BA frame also increases. For example, given 18 OFDMA STAs in 40 MHz, if a BA frame has a size of 238 bytes and is transmitted in MCS 0, the resulting overhead is 85 symbols (340 μs).

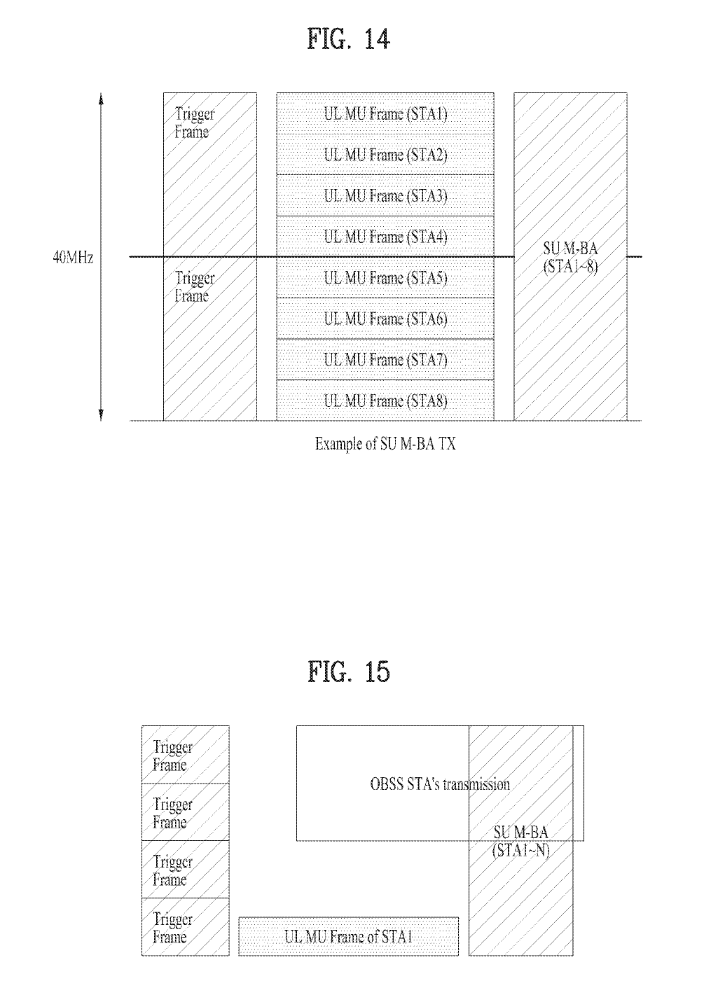

FIGS. 14 and 15 are diagrams illustrating a problem encountered with using a general Multi-user Block ACK (M-BA) frame.

FIG. 14 illustrates a specific case in which an M-BA frame is transmitted in an SU PPDU. An AP may transmit ACK/NACK signals for all STAs in a total bandwidth. In the illustrated case of FIG. 14, if the AP receives data from STA 1 to STA 8 in 40 MHz, the AP transmits ACK/NACK signals for STA 1 to STA 8 in the total 40-MHz band.

However, the use of the M-BA frame may cause the following problem.

As illustrated in FIG. 15, while STA 1 is transmitting a UL frame in resources allocated by a trigger frame, an STA hidden to the AP, that is, an OBSS STA may transmit a frame on another (sub)channel unused by STA 1.

In this case, the frame transmission of the OBSS STA may interfere with reception of an M-BA at STA 1, as illustrated in FIG. 15. In this case, STA 1 may not receive the M-BA frame unprotected by an EIFS operation.

A preferred embodiment of the present disclosure proposes a method for efficiently transmitting a Block ACK, which can solve the above-described problem of interference from an OBSS STA, while minimizing the afore-described overhead.

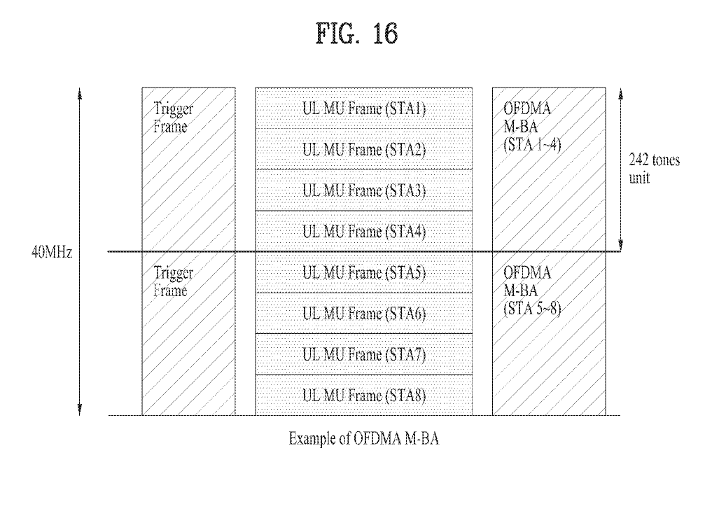

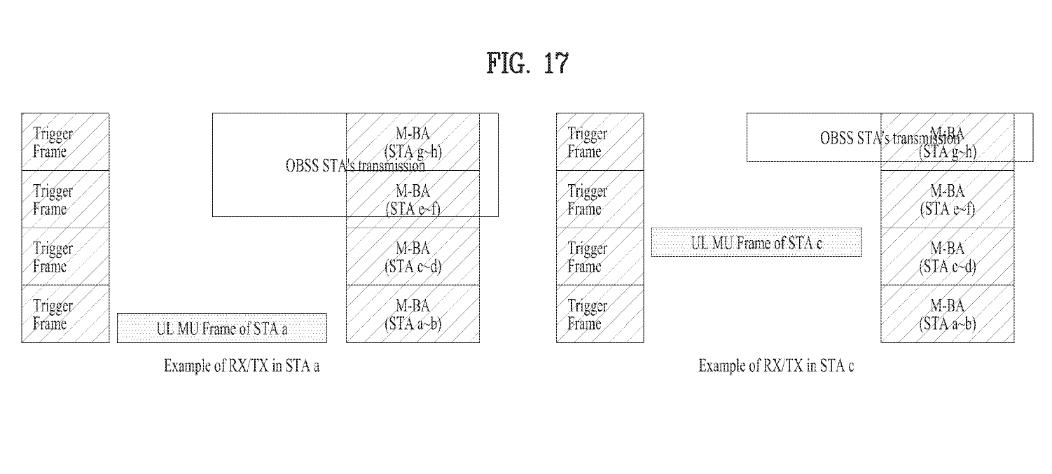

FIG. 16 is a diagram illustrating an M-BA transmission mechanism according to a preferred embodiment of the present disclosure.

In the embodiment, it is proposed that upon receipt of UL MU (OFDMA/MU-MIMO) frames, an AP transmits Block ACKs independently on a specific resource unit basis (e.g., on a chunk (242 tones) or 20-MHz basis).

Specifically as illustrated in FIG. 16, it is proposed that each M-BA frame transmitted in 242 tones carries ACK/NACK signals for STAs from which the AP has received UL data in the 242 tones. This may be referred to as an M-BA frame in the form of an OFDMA PPDU.

In the illustrated case of FIG. 16, the AP receives data from STA 1 to STA 4 in first 242 tones, and data from STA 5 to STA 8 in second 242 tones. Then, the AP may transmit ACK/NACK signals for STA 1 to STA 4 in an OFDMA M-BA in the first 242 tones, and ACK/NACK signals for STA 5 to STA 8 in an OFDMA M-BA in the second 242 tones.

FIG. 17 is a diagram illustrating an advantage of using the OFDMA M-BA frames illustrated in FIG. 16.

As described above, OFDMA M-BA frames according to the embodiment may be transmitted on a 242-tone basis, and ACKs/BA for STAs from which the AP has received data in 242 tones may be transmitted in the 242 tones.

As illustrated in the left drawing of FIG. 17, if STA a transmits a UL MU frame in fourth 242 tones, STA a may receive an ACK/BA for the UL MU frame in an OFDMA M-BA transmitted in the fourth 242 tones, which may avoid interference from an OBSS STA as described before with reference to FIG. 15. The right drawing of FIG. 17 illustrates a case in which STA c transmits a UL MU frame in third 242 tones. In this case, interference from an OBSS STA may also be avoided.

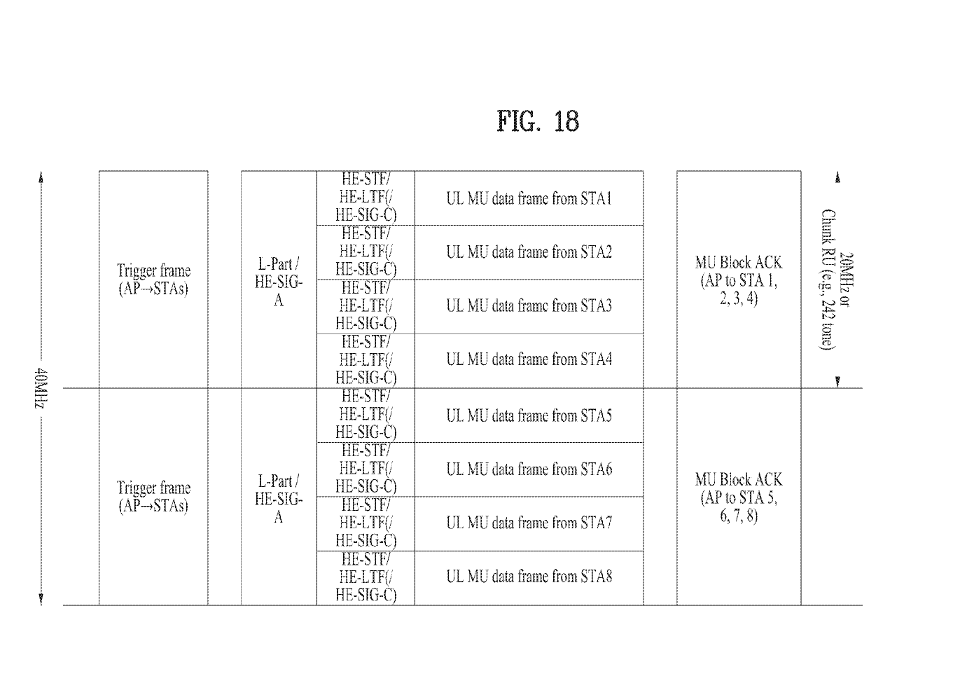

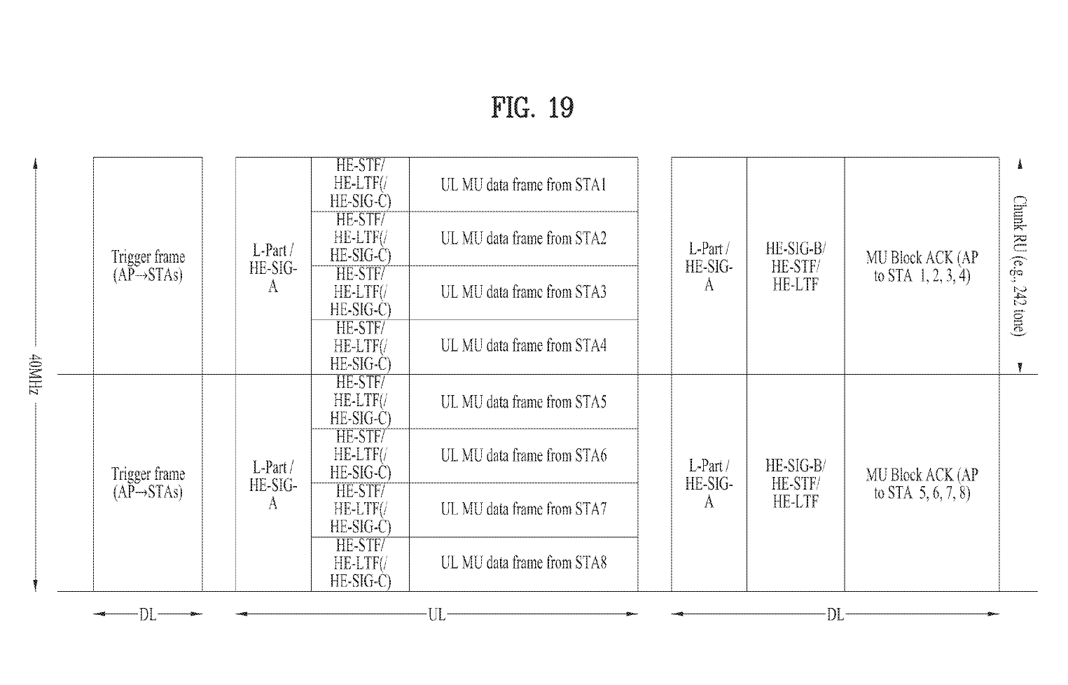

FIG. 18 is a diagram illustrating a specific mechanism using the OFDMA M-BA frames illustrated in FIG. 16.

In FIG. 18, a trigger frame may be duplicated and transmitted on a 20-MHz/chunk Resource Unit (RU) (e.g., 242 tones) basis, or may be transmitted across a total bandwidth. For the convenience of description, it is assumed that a trigger frame is duplicated.

The trigger frame may include resource allocation information for UL MU frame transmissions of STA 1 to STA 8. STA 1 to STA 8 may transmit UL frames in MU in resource areas allocated by the trigger frame. The L-Part of a UL frame may include an L-STF, an L-LTF, and an L-SIG. A HE-SIG-A may include common information such as a BW, a GI, and a BSS color index, and a HE-SIG-C may include user-specific information such as an MCS and a coding rate.

Upon receipt of UL MU frames from the STAs, the AP transmits Block ACKs in response to the UL MU frames. The Block ACKs are transmitted on a 20-MHz basis or on a chunk unit basis (e.g., on a 242 tone basis), and each DL MU Block ACK may include Block ACK information for STAs which have transmitted data in a corresponding chunk unit or 20-MHz resource unit. For example, a first MU Block ACK includes ACK/BA information for STA 1 to STA 4, and a second MU Block ACK includes ACK/BA information for STA 5 to STA 8.

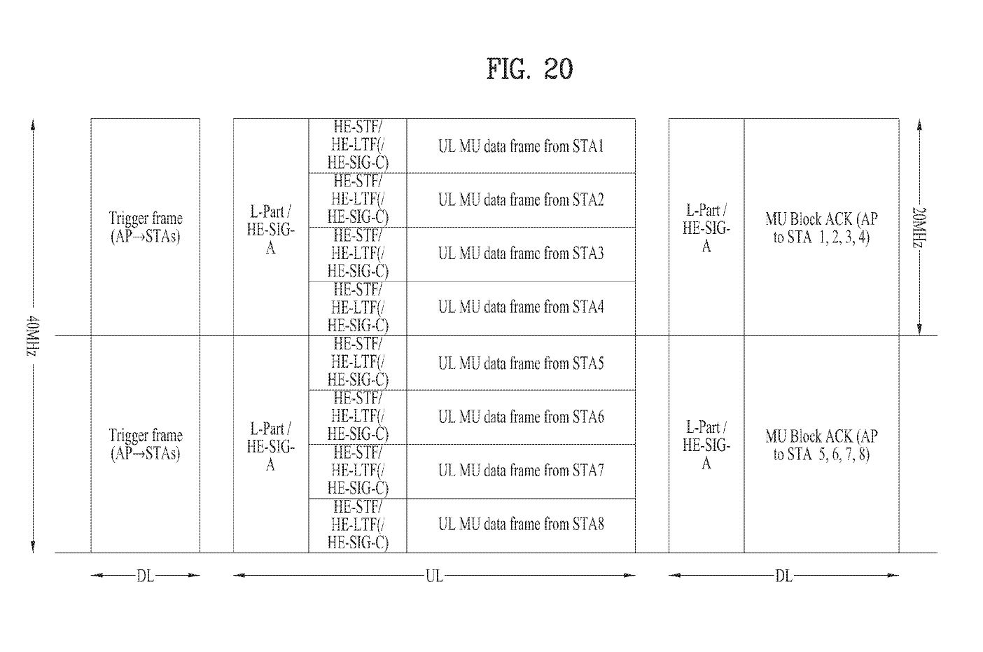

FIGS. 19 and 20 illustrate specific formats for an M-BA frame according to an embodiment of the present disclosure.

Specifically, FIG. 19 illustrates a case of an IEEE 802.11ax PPDU format, and FIG. 20 illustrates a case of an IEEE 802.11a PPDU format.

If MU Block ACKs are transmitted in the 11ax PPDU format on a 242-tone basis, each of the MU Block ACKs may include an L-STF, an L-LTF, and an L-SIG in an L-Part, as illustrated in FIG. 19. A HE-SIG-A may include common information such as a BW, GI, and a BSS color index, and a HE-SIG-B may include MU Block ACK decoding information such as a resource allocation, Nsts, an MCS, and a coding rate.

When a DL MU Block ACK is transmitted in the 11ax format, a receiver ID (e.g., PAID/AID/GID) in a HE-SIG field may be set to a broadcast ID or a multicast ID. A receiver address included in an MPDU of the MU Block ACK may also be set to a broadcast address.

Meanwhile, if DL MU Block ACKs are transmitted in the 11a PPDU format on a 20-MHz basis, an L-Part is followed by an MU Block ACK MPDU in 20 MHz due to the use of the 11a PPDU format.

In FIG. 20, the MU Block ACK MPDU may include the afore-described multi-AID Block ACK format defined in FIG. 13.

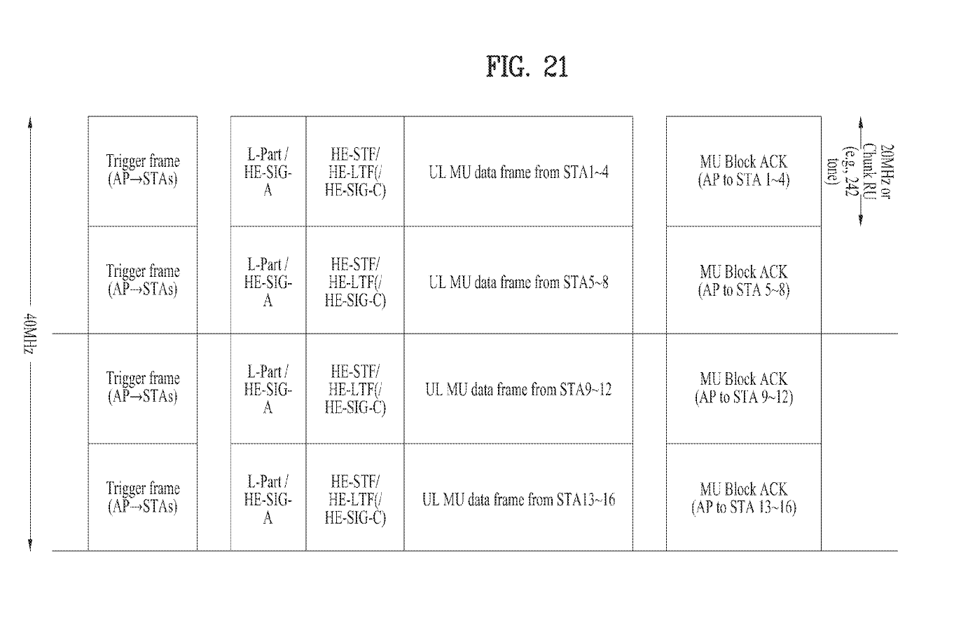

FIG. 21 illustrates exemplary transmission of DL MU BAs from an AP, in the case where UL MU frames are transmitted in 80 MHz.

In FIG. 21, UL MU-MIMO resources are allocated to UL resource areas each having 242 tones (a 20-MHz resource unit). In the above example, MU Block ACKs are also transmitted on a chunk unit basis (e.g., in units of 242 tones) or a 20-MHz basis, and each MU Block ACK includes ACK/BA information for UL MU transmissions of STAs in a corresponding chunk.

Based on the above description, multiplexing of M-BA frames will be described below.

If different numbers of UL MU STAs are allocated to different chunks (or 20-MHz bands), MU Block ACKs transmitted in the chunks may have different lengths.

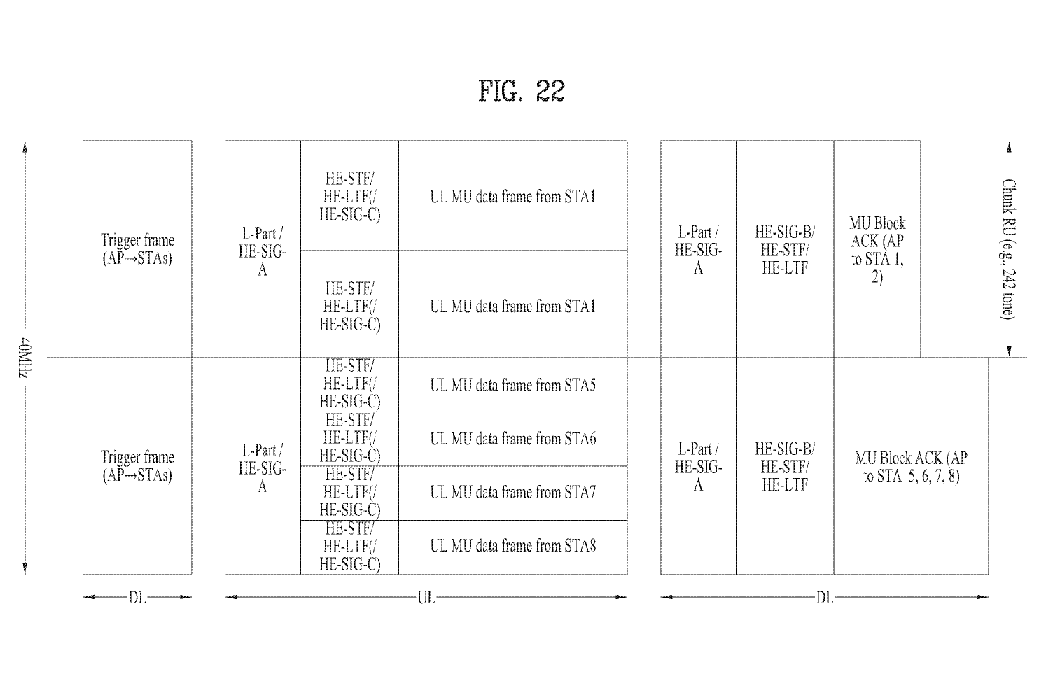

FIG. 22 is a diagram describing different time lengths of M-BA frames, when the M-BA frames are transmitted on a chunk basis.

In the illustrated case of FIG. 22, STA 1 and STA 2 are allocated to a first chunk and thus transmit UL MU frames in the first chunk, whereas STA 5 to STA 8 are allocated to a second chunk and thus transmit UL MU frames in the second chunk. In this case, an MU Block ACK transmitted in the first chunk is smaller in size than an MU Block ACK transmitted in the second chunk. As a consequence, after the MU Block ACK is completely transmitted in the first chunk, another STA may use the first chunk channel, thereby affecting reception of the MU Block ACK at STA 5, STA 6, STA 7, and STA 9.

Therefore, an AP according to an embodiment of the present disclosure may be configured to match the durations of DL MU ACKs to the duration of the longest DL MU ACK, when the AP transmits the DL MU ACKs on a chunk (or 20 MHz) basis. For this purpose, the AP may perform MAC/PHY padding on the shorter DL MU ACKs.

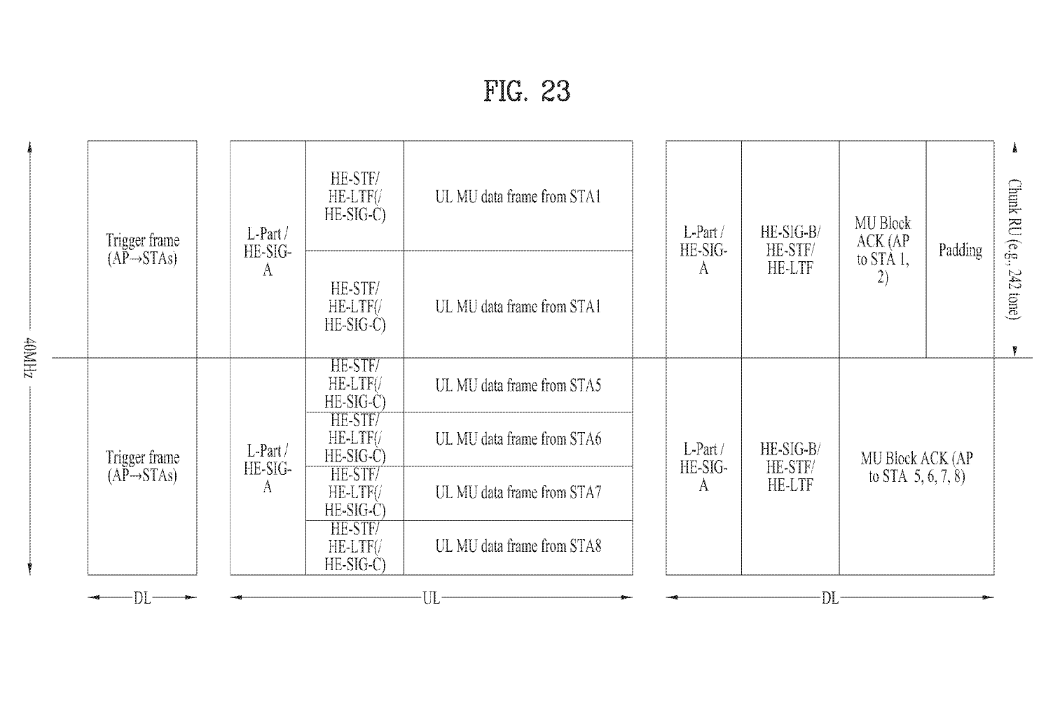

FIG. 23 is a diagram illustrating a method for matching the time lengths of M-BAs in a plurality of bands to each other by padding according to an embodiment of the present disclosure.

That is, if the time length of a first M-BA frame is shorter than that of a second M-BA frame as illustrated in FIG. 22 or 23, the time length of the first M-BA frame may be matched to that of the second M-BA frame by performing PHY or MAC padding on the first M-BA frame.

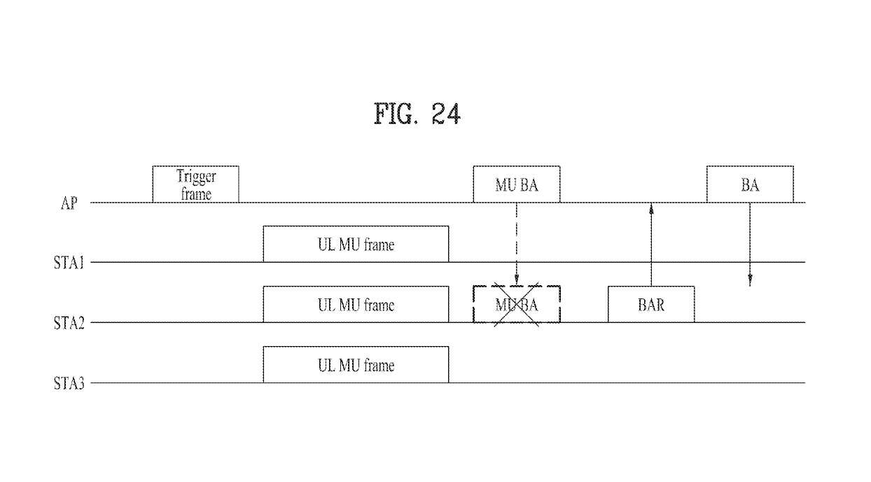

FIG. 24 is a diagram illustrating an operation of an STA which has failed in receiving an M-BA frame according to an embodiment of the present disclosure.

In the example of FIG. 24, if STA 2 fails to receive an MU Block ACK in a resource area (e.g., 20 MHz, chunk region, or resource unit) corresponding to STA 2, STA 2 may perform a procedure for determining whether the AP has successfully received a UL frame.

In the above example, since STA 2 has failed to receive a DL MU BA frame after transmitting a UL MU frame, STA 2 transmits a BAR frame to the AP. The BAR frame is transmitted based on EDCA. Upon receipt of the BAR from STA 2, if the AP has successfully received the UL MU frame from the STA, the AP transmits a BA to STA 2.

Now, a description will be given of a method for setting an ACK/BA type according to an embodiment of the present disclosure.

In an embodiment of the present disclosure, when the AP allocates UL MU transmission resources by a trigger frame, the AP may set and indicate a response frame (e.g., an ACK/BA) Transmission (TX) type. According to each TX type, the AP may transmit a different type of response frame.

<ACK/BA TX Type (1 or 2 Bits)>

0: Duplicated ACK/BA. An M-BA is duplicated and transmitted on a 20-MHz basis.

1: Separate BA. M-BAs are transmitted separately on a 20-MHz basis (11a frame format) or on a chunk basis (e.g., on a 242-tone basis in the flax frame format).

2: OFDMA ACK/BA. ACKs/BAs are transmitted in OFDMA.

3: reserved.

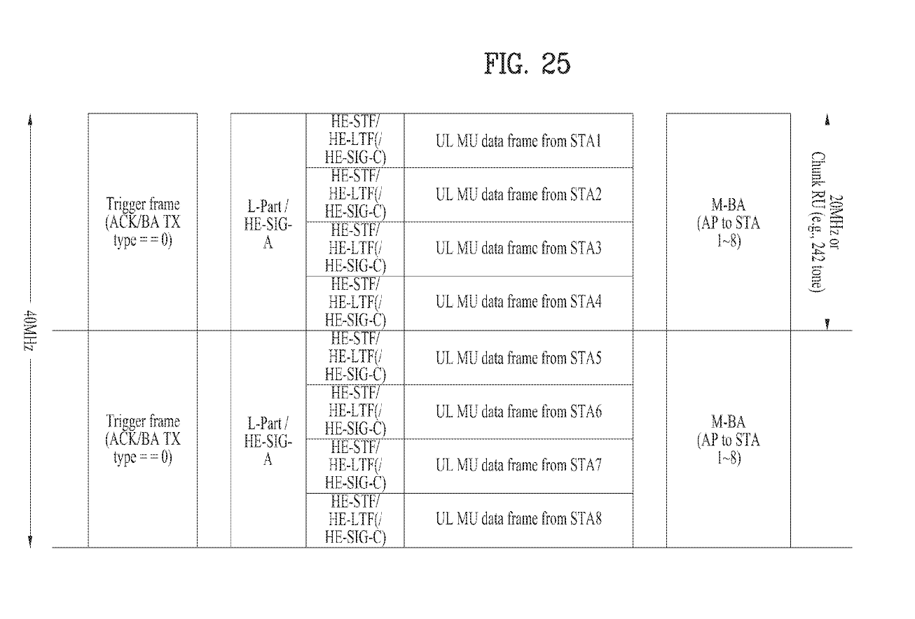

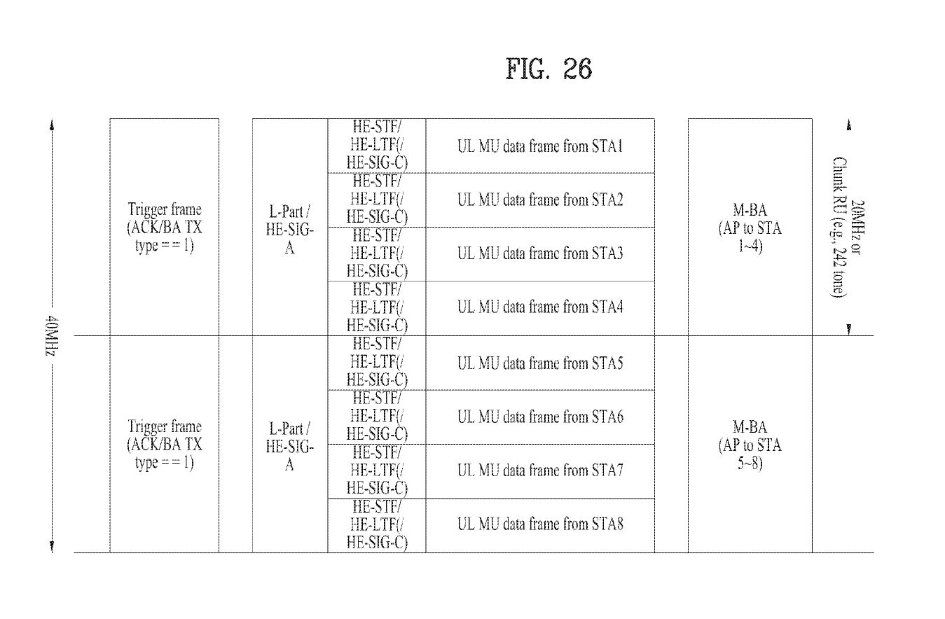

FIGS. 25 and 26 are diagrams illustrating an operation for the case where an ACK/BA type is set according to an embodiment of the present disclosure.

In the example of FIG. 25, it is assumed that the ACK/BA type is set to 0 (i.e., Duplicate ACK/BA). In this case, when the AP transmits a response frame after receiving UL MU frames, the AP includes ACK/BA information for all STAs in an M-BA frame, duplicates the M-BA frame on a 20-MHz or chunk basis, and transmits the duplicates.

On the other hand, it is assumed in FIG. 26 that the ACK/BA TX type is set to 1 (i.e., Separate M-BA). In this case, when the AP transmits a response frame after receiving UL MU frames, the AP includes information for different STAs in M-BA frames on a 20-MHz or chunk basis. In the above example, an M-BA transmitted in first 20 MHz includes ACK/BA information for STA 1 to STA 4, and an M-BA transmitted in second 20 MHz includes ACK/BA information for STA 5 to STA 8.

While it has been assumed in the above description that an ACK/BA type is indicated explicitly by a trigger frame, the ACK/BA type may be indicated implicitly. That is, the ACK TX type may be indicated to STAs explicitly by a trigger frame or implicitly.

For example, it may be defined that if an allocated resource size/PPDU length is less than a specific threshold (e.g. X bytes or Y μs/ms), duplicated BAs/ACKs are used, and a corresponding ACK Type Threshold is transmitted to STAs in a broadcast frame (e.g., a beacon) or a unicast frame (e.g., an associate response frame). Accordingly, when UL resources are allocated to the STAs by a trigger frame, the STAs may use the ACK Type Threshold.

When the STAs transmit UL MU frames after receiving the trigger frame, the AP may determine whether to transmit duplicated M-BAs or separate M-BAs depending on whether CCA has been performed. For example, if the STAs transmit the UL MU frames in allocated areas irrespective of a CCA value an SIFS after receiving the trigger frame, the AP may transmit duplicated M-BAs after receiving the UL MU frames. If the STAs transmit the UL MU frames in the presence of a channel which is idle during a PIFS before receiving the trigger frame, the AP may transmit M-BAs separately on a 20-MHz (or chunk) basis as defined before after receiving the UL MU frames. It may be indicated by the trigger frame whether the UL MU frames are to be transmitted using a CCA threshold.

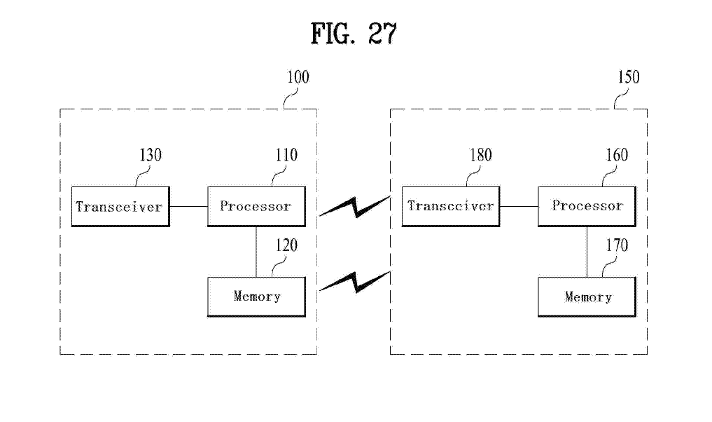

FIG. 27 is a diagram illustrating apparatuses for implementing the above-described methods.

A wireless apparatus 800 of FIG. 27 may correspond to the above-described STA and a wireless apparatus 850 of FIG. 27 may correspond to the above-described AP.

The STA 800 may include a processor 810, a memory 820, and a transceiver 830, and the AP 850 may include a processor 860, a memory 870, and a transceiver 860. The transceivers 830 and 880 may transmit/receive a wireless signal and may be implemented in a physical layer of IEEE 802.11/3GPP. The processors 810 and 860 are implemented in a physical layer and/or a MAC layer and are connected to the transceivers 830 and 880. The processors 810 and 860 may perform the above-described UL MU scheduling procedure.

The processors 810 and 860 and/or the transceivers 830 and 880 may include an Application-Specific Integrated Circuit (ASIC), a chipset, a logical circuit, and/or a data processor. The memories 820 and 870 may include a Read-Only Memory (ROM), a Random Access Memory (RAM), a flash memory, a memory card, a storage medium, and/or a storage unit. If an embodiment is performed by software, the above-described methods may be executed in the form of a module (e.g., a process or a function) performing the above-described functions. The module may be stored in the memories 820 and 870 and executed by the processors 810 and 860. The memories 820 and 870 may be located at the interior or exterior of the processors 810 and 860 and may be connected to the processors 810 and 860 via known means.

The detailed description of the preferred embodiments of the present invention has been given to enable those skilled in the art to implement and practice the present disclosure. Although the present disclosure has been described with reference to the preferred embodiments, those skilled in the art will appreciate that various modifications and variations can be made in the present disclosure without departing from the spirit or scope of the present disclosure described in the appended claims. Accordingly, the present disclosure should not be limited to the specific embodiments described herein, but should be accorded the broadest scope consistent with the principles and novel features disclosed herein.

### INDUSTRIAL APPLICABILITY

While the various embodiments of the present disclosure have been described in the context of an IEEE 802.11 WLAN system, the present disclosure is not limited thereto. The present disclosure is also applicable in the same manner to various WLAN systems in which an AP can perform a Block ACK mechanism for a plurality of STAs.

What is claimed is:

1. A method for transmitting, by an access point (AP), an acknowledgment/negative acknowledgment (ACK/NACK) signal for transmission data of a plurality of stations (STAs) in a wireless local area network (WLAN) system, the method comprising:
transmitting a trigger frame to the plurality of STAs;
receiving data from the plurality of STAs in response to the trigger frame; and
transmitting an ACK/NACK signal for the data received from the plurality of STAs,
wherein the ACK/NACK signal is transmitted in a multi-user block ACK (M-BA) frame configured to include a 242-tone unit.

2. The method according to claim 1, wherein a specific M-BA frame transmitted in specific 242 tones includes an ACK/NACK signal for data received in the specific 242 tones.

3. The method according to claim 1, wherein if a first group of data are received in first 242 tones from a first group of STAs among the plurality of STAs, and a second group of data are received in second 242 tones from a second group of STAs among the plurality of STAs, a first M-BA frame including ACK/NACK signals for the first group of STAs is transmitted in the first 242 tones, and a second M-BA frame including ACK/NACK signals for the second group of STAs is transmitted in the second 242 tones.

4. The method according to claim 3, wherein if the first M-BA frame and the second M-BA frame have different time lengths, the time lengths of the first M-BA frame and the second M-BA frame are made equal by inserting a padding in an M-BA frame having a shorter time length.

5. The method according to claim 1, wherein the M-BA frame is configured in a PLCP protocol data unit (PPDU) format having a legacy-part (L-Part), a high efficiency signal A (HE-SIG A), a high efficiency signal B (HE-SIG B), a high efficiency short training field (HE-STF), a high efficiency long training field (HE-LTF), and a data field including a plurality of ACK/NACK signals.

6. The method according to claim 5, wherein the HE-SIG B includes information for decoding the plurality of ACK/NACK signals in the data field.

7. The method according to claim 1, wherein the M-BA frame is configured in a PPDU format including an MU block ACK MAC protocol data unit (MPDU) after an L-Part.

8. The method according to claim 1, wherein the AP indicates, to the plurality of STAs, ACK/NACK type information indicating whether ACK/NACK signals are transmitted in M-BA frames duplicated on a 242-tone basis, in M-BA frames each including an independent ACK/NACK signal on a 242-tone basis, or in OFDMA.

9. The method according to claim 8, wherein the AP transmits the ACK/NACK type information in the trigger frame.

10. A method for receiving, from an access point (AP), an acknowledgment/negative acknowledgment (ACK/NACK) signal for transmission data by a first station (STA) in a wireless local area network (WLAN) system, the method comprising:
receiving a trigger frame directed to a plurality of STAs including the first STA;
transmitting a plurality of data to the AP in an uplink multi-user scheme or orthogonal frequency division multiple access (OFDMA) in response to the trigger frame; and
receiving an ACK/NACK signal for the data from the AP,
wherein the ACK/NACK signal is received in a multi-user block ACK (M-BA) frame configured to include a 242-tone unit.

11. An access point (AP) for transmitting an acknowledgment/negative acknowledgment (ACK/NACK) signal for transmission data of a plurality of stations (STAs) in a wireless local area network (WLAN) system, the AP comprising:
a transceiver configured to transmit a trigger frame to the plurality of STAs, receive data from the plurality of STAs in response to the trigger frame, and transmit an ACK/NACK signal for the data received from the plurality of STAs; and
a processor connected to the transceiver and configured to process the trigger frame, the received data, and the ACK/NACK signal,
wherein the processor configures the ACK/NACK signal in a multi-user block ACK (M-BA) frame configured to include a 242-tone unit.

12. A station (STA) operating as a first STA for receiving, from an access point (AP), an acknowledgment/negative acknowledgment (ACK/NACK) signal for transmission data in a wireless local area network (WLAN) system, the STA comprising:
a transceiver configured to receive a trigger frame directed to a plurality of STAs including the first STA, transmit a plurality of data to the AP in an uplink multi-user scheme or orthogonal frequency division multiple access (OFDMA) in response to the trigger frame, and receive an ACK/NACK signal for the data from the AP; and
a processor connected to the transceiver and configured to process the trigger frame, the received data, and the ACK/NACK signal,
wherein the processor is configured to process an ACK/NACK signal received in a multi-user block ACK (M-BA) frame configured to include a 242-tone unit.
